(19) United States
(12) Patent Application Publication
(10) Pub. No.: US 2016/0123636 A1
(43) Pub. Date: May 5, 2016

(54) METHOD FOR OPERATING A HEAT PUMP AND HEAT PUMP

(71) Applicant: SIEMENS AKTIENGESELLSCHAFT, München (DE)

(72) Inventors: Bernd GROMMOLL, Baiersdorf (DE); Florian REISSNER, Nuremberg (DE); Jochen SCHÄFER, Nuremberg (DE)

(73) Assignee: SIEMENS AKTIENGESELLSCHAFT, München (DE)

(21) Appl. No.: 14/898,040

(22) PCT Filed: Jun. 5, 2014
(86) PCT No.: PCT/EP2014/061692

§ 371 Date: Dec. 11, 2015

(30) Foreign Application Priority Data
Jun. 14, 2013 (DE) 10 2013 211 084.7

(51) Int. Cl. F25B 31/00; C09K 5/04; F25B 30/02

(52) U.S. Cl. CPC F25B 31/006; F25B 30/02; C09K 5/044

(57) ABSTRACT

A fluid is condensed by at least one condensation device and the fluid is expanded by at least one expansion device. Then, the fluid is evaporated by at least one evaporation device and the fluid is compressed by at least one compression device. An ionic liquid is used when compressing the fluid.

### CROSS REFERENCE TO RELATED APPLICATIONS

This application is the U.S. national stage of International Application No. PCT/EP2014/061692, filed Jun. 5, 2014 and claims the benefit thereof. The International Application claims the benefit of German Application No. 102013211084.7 filed on Jun. 14, 2013, both applications are incorporated by reference herein in their entirety.

### BACKGROUND

Described below are a method for operating a heat pump and a heat pump.

Heat pumps are often used to provide industrial useful heat. A heat pump is a machine which, by using technical work, absorbs thermal energy in the form of heat at a lower temperature from a heat source and, together with the drive energy of a compression machine, releases it as waste heat at a higher temperature to a heat sink. For temporary storage or to transfer heat, a fluid is used, which is compressed and conveyed in a cycle process within the heat pump by the compression machine.

It is known that in heat pumps or vapor compression heat pumps a compressor is used as the compression machine, i.e. as the drive machine. Commercial compressors which are used in heat pumps include inter alia displacement compressors, screw compressors or for example turbocompressors. The temperature level of the useful waste heat from heat pumps is currently limited primarily by the temperature compatibility of the compressor components used. The compressor for example draws in a gaseous fluid at a given temperature and compresses it to a desired higher pressure. Depending on the value of the isentropic exponent of the drawn-in gas, the process of compression increases the gas temperature to different degrees as a result of compression to a “final compression temperature”. It is often the case that the compressor fails as soon as the temperature of the drawn-in gas exceeds a value of 70° C. Experience shows that a temperature value of this order of magnitude is particularly critical if the compressors used are “hermetically sealed rotary compressors”. For instance, tight compressor component fits, for example the screw pair fit in screw compressors, are affected to a particular degree by temperature-related thermal expansion. If, for example, different components of the screw compressor expand thermally to different degrees due to non-uniform temperature exposure, rotating components may come into contact with the housing or the rotating components may come into contact with one another, which leads to failure of the respective compressor. Experience shows that a further problem is the lubrication of oil-lubricated compressors at high fluid temperatures. Appropriate oils, which are used in compressors for the purpose of lubrication, must not exceed a maximum utilization temperature limit for extended periods. If this utilization temperature limit is exceeded for an extended period, coking of the oil occurs and the compressor lubricating function is consequently impaired. It is known that the maximum temperature limit for lubricant oils used is of the order of magnitude of 140° C., wherein this temperature limit must not be exceeded for extended periods if the lubricating function of the oil is to be maintained.

### SUMMARY

Described below are a method and a heat pump of the above-stated type which is suitable for continuous operation at particularly high fluid temperatures.

In the method for operating a heat pump described below, an ionic liquid is used during fluid compression.

Provided they are not flammable and are thermally stable, ionic liquids are particularly suitable for compression of the fluid. In other words, exposure of the ionic liquid to elevated temperatures is thus particularly non-critical, since ignition of the ionic liquid is not to be expected. Due to their very low vapor pressure, virtually no measurable evaporation phenomena arise with ionic liquids. Due to their thermal stability, in comparison specifically with oils, there is no risk of coking at higher operating temperatures. An ionic liquid is understood to mean organic salts, the ions of which prevent the formation of a stable crystal lattice through charge delocalization and steric effects. Even low thermal energies are therefore sufficient to overcome the lattice energy and break up the solid crystal structure. Ionic liquids are thus salts which are liquid at temperatures of below 100° C., without the salt being dissolved in a solvent such as water. The ions contained in ionic liquids can be subdivided into positively charged ions, i.e. “cations”, and negatively charged ions, i.e. “anions”. By varying the various types of cations and anions contained in the ionic liquid and by establishing different concentrations of cations and anions, the physico-chemical properties of an ionic liquid may be varied within particularly broad limits and optimized with regard to technical requirements. For example, the solubility and melting point of an ionic liquid may be influenced by changing the composition and ion concentration.

In one advantageous configuration, the fluid releases a quantity of heat to the ionic liquid. An undesired fluid temperature rise is particularly efficiently prevented if the fluid releases some of its quantity of heat to the ionic liquid. In other words, the ionic liquid is thus used to cool the fluid on compression thereof. For example, the temperature of the ionic liquid may be lowered such that the fluid may release a particularly large quantity of heat to the ionic liquid and consequently a final compression temperature of the fluid may be kept at a non-critical level.

It has also proven advantageous for the quantity of heat to be released by a heat exchanger. Using a heat exchanger, the quantity of heat previously released by the fluid to the ionic liquid may be particularly effectively dissipated, whereby the ionic liquid is once again cooled and is again able to absorb heat from the fluid.

It is particularly advantageous for the quantity of heat to be transferred at least in part by the heat exchanger to the evaporation apparatus and/or to an external consumer. If the dissipated quantity of heat is transferred to the evaporation apparatus of the heat pump, the heat pump may be operated in a particularly energy-efficient manner, since, depending on the quantity of heat which is supplied to the evaporation apparatus by the heat exchanger, a correspondingly smaller additional amount of energy has to be released to the evaporation apparatus to allow evaporation of the fluid. In other words, the additional, external quantity of heat supplied to the evaporation apparatus of the heat pump may be reduced due to the quantity of heat supplied by the heat exchanger, whereby the energy input for operation of the heat pump as a whole may be reduced. It is moreover possible to supply an external consumer the quantity of heat transferred by the heat exchanger. This external consumer may for example take the form of a thermoelectric generator, or a Stirling engine. In other words, the quantity of heat may be converted particularly efficiently into another form of energy, i.e. for example into electrical or mechanical energy, and as such made useful.

In a further advantageous configuration, a liquid ring compressor is used as the compression apparatus. A liquid ring compressor is substantially formed by a cylindrical housing, which encompasses an eccentrically arranged rotor with blades distributed evenly in a stellate arrangement on the rotor. The longitudinal cylinder axis of the housing here extends parallel to a drive axis of an eccentrically arranged rotor. The ionic liquid which, as a result of a centrifugal force on rotation of the rotor, forms a liquid ring concentric to the housing, is located in the housing. Through immersion of the blades of the rotor arranged in a stellate arrangement, impeller chambers are formed, which are sealed by the liquid ring of the ionic liquid. In other words, the corresponding impeller chamber is formed by interaction of the liquid ring, and of in each case two blades arranged on the rotor and the rotor itself, the respective impeller chamber being defined at the end face by respective covers defining the cylindrical housing. Due to the eccentricity of the rotor, a gas, corresponding to the fluid, is compressed on rotation of the rotor, since the respective blades are immersed more deeply into the liquid ring due to the eccentricity of the rotor. The fluid is then drawn in by the liquid ring compressor at a location at which respective blades are immersed merely to a small extent in the liquid ring and thus the chamber volume is at its maximum. With substantially half a revolution of the eccentric rotor, the blades are then immersed maximally in the liquid ring as a result of the eccentricity, whereby the fluid contained in the chamber is compressed to a maximum achievable value. On achievement of this maximum compression, the compressed fluid exits from the cylindrical housing through bores in the covers of the liquid ring compressor defining the housing. In this way, the fluid is moved in the heat pump by the liquid ring compressor. Since the ionic liquid forms the liquid ring in the liquid ring compressor, the liquid ring compressor may be operated in a particularly failsafe manner even at elevated fluid temperatures. The chambers of the liquid ring compressor are sealed in the radial direction by the liquid ring, whereby contact of the blades with the housing may be wholly prevented. Thus, contact-related sparking is ruled out, so also enabling the delivery and compression of explosive fluids.

It has further proven advantageous for the ionic liquid to have a miscibility gap with regard to the fluid in the physical states prevailing during compression. In the case of a substance mixture, a miscibility gap denotes a thermodynamic state in which the components of the corresponding substance mixture do not mix, i.e. are insoluble. In other words, in this thermodynamic state a substance mixture is in at least two different phases with different compositions. These phases are in thermodynamic equilibrium with one another.

It is particularly advantageous for a separating apparatus to be used downstream of the compression apparatus, in order to separate the ionic liquid from the fluid. By using a separating apparatus in the form of a gas/liquid separator, the ionic liquid may be separated particularly effectively from the fluid. Owing to the fact that the ionic liquid and the fluid come into contact during compression of the fluid by the liquid ring compressor, it may so happen that parts of the ionic liquid exit the liquid ring compressor together with the compressed fluid and thus enter the heat pump circuit. By using a gas/liquid separator, the ionic liquid may be separated particularly extensively from the fluid-conveying circuit of the heat pump downstream of the liquid ring compressor.

It is particularly advantageous if the ionic liquid may be added to the fluid via a secondary circuit. The quantity of heat released to the ionic liquid through compression of the fluid may be particularly extensively dissipated if the ionic liquid may be added to the fluid via a secondary circuit. This secondary circuit corresponds to a circuit independent of the fluid circuit of the heat pump which is particularly well suited to passing on the dissipated quantity of heat to a heat exchanger, by which the ionic liquid is cooled again. In other words, using the secondary circuit, the liquid ring compressor may be continuously cooled by the ionic liquid.

It has additionally proven advantageous for the ionic liquid to be at least substantially separable in a separator downstream of the compression apparatus. Extensive separation of the ionic liquid is particularly important since the fluid and the ionic liquid have different material properties. Since the ionic liquid is not suitable for passing through the various working processes (compression, condensation, expansion and evaporation) together with the fluid, separation of the ionic liquid allows particularly extensive maintenance of the efficiency and functionality of the heat pump.

### BRIEF DESCRIPTION OF THE DRAWINGS

Further advantages, features and details will become more apparent and more readily appreciated from the following description of preferred embodiments and with reference to the FIGURE.

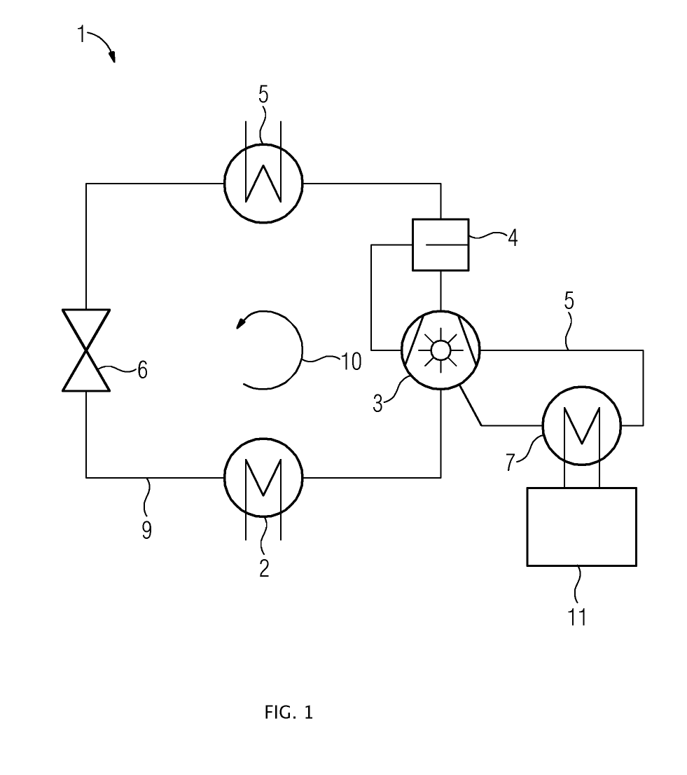

The single FIGURE (FIG. 1) is a schematic representation of a cycle process of a thermodynamic vapor compression cycle for a heat pump with a liquid ring compressor.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

FIG. 1 is schematic representation of a heat pump 1 in which a fluid is delivered in accordance with the direction of arrow 10 by a compression apparatus, which takes the form of a liquid ring compressor 3. The fluid is firstly evaporated by an evaporation apparatus, which takes the form of an evaporator 2, and is then compressed by the liquid ring compressor 3. The liquid ring compressor 3 is coupled fluidically with a liquid circuit 8, wherein the liquid ring compressor 3 is supplied with an ionic liquid by the liquid circuit 8. The ionic liquid is used in the liquid ring of the liquid ring compressor 3, wherein this liquid ring serves to compress the fluid. The ionic liquid is in fluidic contact with the fluid of the heat pump 1 and, in the case of the operating parameters which apply to the liquid ring compressor 3 and in the case of a given composition of the ionic liquid and of the fluid, exhibits a miscibility gap with regard to the fluid. Through its contact with the fluid, the ionic liquid thus absorbs some of the quantity of heat of the fluid and this quantity of heat is continuously dissipated by the movement of the ionic liquid within the liquid circuit 8. During compression of the fluid in the liquid ring compressor 3 by the ionic liquid, some of the ionic liquid flows into a media circuit 9, which corresponds to the fluid circuit of the heat pump. To remove this proportion of the ionic liquid from the media circuit 9 again, a separating apparatus is used, which takes the form of a separator 4. The separator 4, in other words, separates the ionic liquid from the fluid contained in the media circuit 9, whereupon the ionic liquid is re-supplied to the liquid circuit 8. To dissipate from the liquid circuit 8 the heat released during compression by the liquid ring compressor 3 from the fluid to the ionic liquid, a heat exchanger 7 is integrated into the liquid circuit 8, by which heat exchanger 7 the dissipated quantity of heat is dissipated at least substantially to a heat sink 11, which is coupled to an external consumer, and/or to the evaporator 2. By supplying at least some of the heat to the evaporator 2, the energy input for operation of the evaporator 2 may be reduced. The quantity of heat released to the heat sink 11 may be used to supply the consumer, not shown here in any greater detail, with thermal energy.

The heat pump 1 additionally includes a condensation apparatus arranged downstream of the separator 4 in the direction of the arrow 10, which condensation apparatus takes the form of a condenser 5 and serves to condense the fluid. After condensation of the fluid by the condenser 5, the fluid is expanded by an expansion apparatus, which takes the form of an expansion valve 6. After expansion of the fluid, the fluid once again enters the evaporator 2. The media circuit 9 is thus closed.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for operating a heat pump, comprising:
condensing a fluid by at least one condensation apparatus;
expanding the fluid by at least one expansion apparatus;
evaporating the fluid by at least one evaporation apparatus;
compressing the fluid by at least one compression apparatus using an ionic liquid.

12. The method as claimed in claim 11, further comprising releasing a quantity of heat from the fluid to the ionic liquid during said compressing.

13. The method as claimed in claim 12, wherein said releasing of the quantity of heat uses a heat exchanger.

14. The method as claimed in claim 13, further comprising transferring the quantity of heat at least in part by the heat exchanger to at least one of the evaporation apparatus and an external consumer.

15. The method as claimed in claim 11, wherein the compression apparatus is a liquid ring compressor.

16. The method as claimed in claim 11, wherein the ionic liquid exhibits a miscibility gap with regard to the fluid in physical states prevailing during said compressing.

17. The method as claimed in claim 11, further comprising separating the ionic liquid from the fluid a separation apparatus downstream of the compression apparatus.

18. A heat pump, comprising:
at least one condensation apparatus condensing a fluid;
at least one expansion apparatus expanding the fluid;
at least one evaporation apparatus evaporating the fluid; and
at least one compression apparatus adding an ionic liquid and compressing the fluid.

19. The heat pump as claimed in claim 18, further comprising a secondary circuit supplying the ionic liquid added to the fluid.

20. The heat pump as claimed in claim 18, further comprising a separator, downstream of the compression apparatus, substantially separating the ionic liquid from the fluid.
